(19) United States
(12) Patent Application Publication
(10) Pub. No.: US 2023/0222933 A1
(43) Pub. Date: Jul. 13, 2023

(54) LEARNING DEVICE, LEARNING METHOD, AND LEARNING PROGRAM

(71) Applicant: NEC Corporation, Minato-ku, Tokyo (JP)

(72) Inventors: Hiroshi TAMANO, Tokyo (JP); Toshiyuki KATAOKA, Tokyo (JP)

(73) Assignee: NEC Corporation, Minato-ku, Tokyo (JP)

(21) Appl. No.: 17/927,219

(22) PCT Filed: May 27, 2020
(86) PCT No.: PCT/JP2020/020926

§ 371 Date: Nov. 22, 2022

(51) Int. Cl. G09B 7/00

(52) U.S. Cl. CPC G09B 7/00

(57) ABSTRACT

The learning device 80 includes a first learning means 81 and a second learning means 82. The first learning means 81 generates a skill state sequence representing time-series changes in a learner's skill state by machine learning using learner's learning results. The second learning means 82 learns a model in which problem characteristics that represent characteristics of problems used by a learner for learning, user characteristics that represent characteristics of the learner, and time information that represents time the learner solved the problem are explanatory variables, and the learner's skill state represented by the skill state sequence is an objective variable.

### TECHNICAL FIELD

The present invention relates to a learning device, a learning method, and a learning program for learning a model for predicting changes in a learner's skills.

### BACKGROUND ART

In order to make education more effective, it is important to provide education that is tailored to individual learners. Such a system is called adaptive learning. To realize such the system, computers are required to automatically provide skills tailored to each individual learner. Specifically, it is necessary to constantly trace the state of knowledge of each learner and provide appropriate learning according to that state of knowledge. This technology for tracing the state of each learner's knowledge and providing appropriate information is also called as knowledge tracing.

Knowledge tracing visualizes the skills of learners to grasp their learning status in real time, predicts whether or not they will be able to solve problems, and provides optimal problems tailored to them. For example, Patent Literature (PTL) 1 describes a test generation server that supports effective review by closely grasping the student's own proficiency level for each study content, and also generates a collection of exercise problems optimized for the student's own proficiency level for each study content, etc.

Various types of knowledge tracing have been proposed that allow the system to follow the learner's interactions in real time. Non Patent Literature (NPL) 1 describes a method for real-time knowledge tracing. The method described in NPL 1 uses Recurrent Neural Networks (RNN) to model student learning.

NPL 2 describes interpretable knowledge tracing with a probabilistic model with a non-compensating item response model.

### CITATION LIST

### Patent Literature

PTL 1: Japanese Patent Application Laid-Open No. 2012-93691

### Non Patent Literature

NPL 1: Chris Piech, et al., “Deep Knowledge Tracing,” Advances in Neural Information Processing Systems 28 (NIPS 2015), 2015.
NPL 2: Hiroshi Tamano and Daichi Mochihashi, “Non-compensatory Temporal IRT with Local Variational Approximation,” Shingakugiho, vol. 119, no. 360, IBISML2019-31, pp. 91-98, January 2020.

### SUMMARY OF INVENTION

### Technical Problem

As in the test generation server described in PTL 1, generally, Artificial Intelligence (AI) judges the learner's skills and presents appropriate problems. At first glance, such a learning method in which the learner unilaterally solves the problems presented by the AI may be considered efficient. However, if only the learning method in which the learner unilaterally solves the presented problems is used, while the learner's ability to solve the asked problems may improve, the learner may not acquire the ability to think independently about how to deal with his or her own weaknesses.

Therefore, it is desirable to be able to provide a learning method that allows learners to decide for themselves what to study while interacting with the AI, i.e. a learning method that allows learners to use the AI proactively. To this end, it is necessary to provide feedback information that enables learners to formulate their own learning plans while grasping transition of their own skills over the long term.

For example, the test generation server described in PTL 1 displays the learning achievement rate in three levels: “∘ (circle indicating all correct answers),” “Δ (triangle indicating some incorrect answers),” and “x (cross indicating all incorrect answers),” according to the ratio of the number of correct answers to the number of problems asked in a small unit. However, since the content of the display described in PTL 1 only shows the results of correct or incorrect answers, it is not possible to grasp the degree to which the user has fulfilled the skills required to solve the asked problems.

The methods described in NPL 1 and NPL 2 can also be used to predict the probability of solving a problem at the present time based on the estimated skills of the learner. However, the methods described in NPL 1 and NPL 2 do not take into account the prediction of future changes in skill as learning progresses. Ultimately, it is preferable to obtain information not on whether or not a particular problem can be solved, but on how the skill will improve in the future if what the learning process is continued.

Therefore, it is an object of the present invention to provide a learning device, a learning method, and a learning program that can learn a model for predicting changes in learner's long-term skills.

### Solution to Problem

A learning device according to the present invention includes a first learning means which generates a skill state sequence representing time-series changes in a learner's skill state by machine learning using learner's learning results, and a second learning means which learns a model in which problem characteristics that represent characteristics of problems used by a learner for learning, user characteristics that represent characteristics of the learner, and time information that represents time the learner solved the problem are explanatory variables, and the learner's skill state represented by the skill state sequence is an objective variable.

A learning method according to the present invention, implemented by a computer, includes generating a skill state sequence representing time-series changes in a learner's skill state by machine learning using learner's learning results, and learning a model in which problem characteristics that represent characteristics of problems used by a learner for learning, user characteristics that represent characteristics of the learner, and time information that represents time the learner solved the problem are explanatory variables, and the learner's skill state represented by the skill state sequence is an objective variable.

A learning program according to the present invention, causing a computer to execute a first learning process of generating a skill state sequence representing time-series changes in a learner's skill state by machine learning using learner's learning results, and a second learning process of learning a model in which problem characteristics that represent characteristics of problems used by a learner for learning, user characteristics that represent characteristics of the learner, and time information that represents time the learner solved the problem are explanatory variables, and the learner's skill state represented by the skill state sequence is an objective variable.

### Advantageous Effects of Invention

According to this invention, it is possible to learn a model for predicting changes in learner's long-term skills.

### BRIEF DESCRIPTION OF DRAWINGS

FIG. 1 It depicts a block diagram showing an example of the configuration of a learning device of the first exemplary embodiment according to the present invention.

FIG. 2 It depicts an explanatory diagram showing an example of learning data.

FIG. 3 It depicts an explanatory diagram showing an example of relating problems to the required skills.

FIG. 4 It depicts a flowchart showing an example of the operation by the learning device.

FIG. 5 It depicts a block diagram showing an example of the configuration of a visualization system of an exemplary embodiment according to the present invention.

FIG. 6 It depicts an explanatory diagram showing an example of a screen for entering a learning plan.

FIG. 7 It depicts an explanatory diagram showing an example of visualizing skill states.

FIG. 8 It depicts an explanatory diagram showing an example of visualizing the probability of solving a problem.

FIG. 9 It depicts an explanatory diagram showing an example of outputting the state of each skill by a graph.

FIG. 10 It depicts an explanatory diagram showing an example of a likelihood function for the probability of correct answers.

FIG. 11 It depicts an explanatory diagram representing the information of the uncompensated model schematically.

FIG. 12 It depicts an explanatory diagram showing an example of the process of computing a threshold value.

FIG. 13 It depicts an explanatory diagram showing an example of the process of visualizing the results.

FIG. 14 It depicts an explanatory diagram showing an example of the output of recommended problems.

FIG. 15 It depicts an explanatory diagram showing another example of visualizing changes in skill state.

FIG. 16 It depicts an explanatory diagram showing yet another example of visualizing changes in skill state.

FIG. 17 It depicts a flowchart showing an example of the operation by the visualization device.

FIG. 18 It depicts a block diagram showing an overview of the learning device according to the present invention.

FIG. 19 It depicts a schematic block diagram showing the configuration of a computer for at least one exemplary embodiment.

### DESCRIPTION OF EMBODIMENTS

Hereinafter, exemplary embodiments of the present invention are described with reference to the drawings.

### Exemplary Embodiment 1

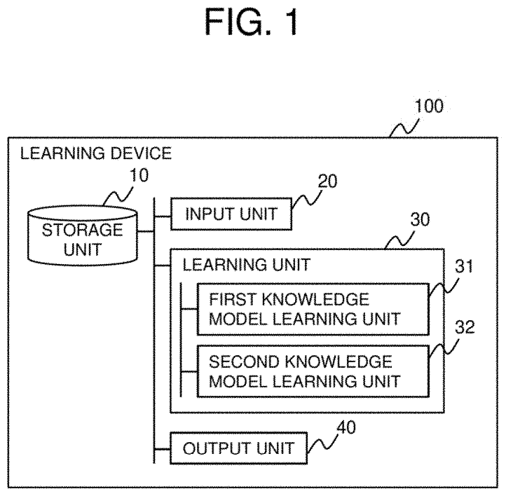

FIG. 1 is a block diagram showing an example of the configuration of a learning device of an exemplary embodiment according to the present invention. The learning device 100 of this exemplary embodiment includes a storage unit 10, an input unit 20, a learning unit 30, and an output unit 40.

The storage unit 10 stores various types of information, such as parameters, setting information, and log data used by the learning device 100 of this exemplary embodiment for processing. Specifically, the storage unit 10 stores learning results that indicate whether or not a certain problem was answered correctly (hereinafter referred to as the learning correct/incorrect log). The contents of the learning correct/incorrect log will be described later. The storage unit 10 may also store each model generated by the learning unit 30, which will be described later.

The learning device 100 may be configured to acquire various types of information from other devices (e.g., storage servers) via a communication network. In this case, the storage unit 10 may not store the information described above. The storage unit 10 is realized by, for example, such as a magnetic disk.

The input unit 20 accepts input of various information used by the learning unit 30 for processing. For example, the input unit 20 may acquire various information from the storage unit 10, or may accept input of various information acquired via a communication network.

In this exemplary embodiment, the input unit 20 accepts the input of the learner's time series of learning correct/incorrect logs as learning data indicating learning results. Specifically, the input unit 20 accepts the input of learning data that includes data that relates problems and the correctness or incorrectness of those problems to information that represents the characteristics of the learner (hereinafter sometimes referred to as user characteristics).

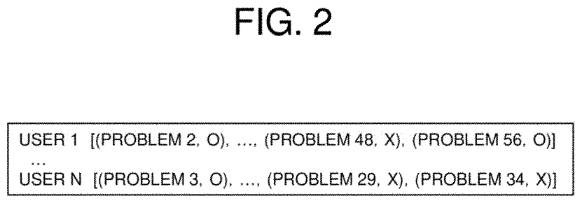

FIG. 2 is an explanatory diagram showing an example of learning data. The learning data illustrated in FIG. 2 indicates that the data relates to the correctness or incorrectness (∘, x) for each problem for the learners, user 1 through user N. The user characteristics, which indicate the characteristics of each user, may be maintained separately from the learning data.

The learning unit 30 includes a first knowledge model learning unit 31 and a second knowledge model learning unit 32.

The first knowledge model learning unit 31 generates time-series changes in the state of the learner's skills (hereinafter referred to as the skill state sequence) by machine learning using the learner's learning results. The learner's skill state is, for example, the proficiency level of the learner's skill.

If the skill state sequence can be generated from the learning results, the learning method is arbitrary. The first knowledge model learning unit 31 may, for example, generate the skill state sequence using the method described in NPL 2. Specifically, the first knowledge model learning unit 31 may generate as the skill state sequence the state with the maximum posterior probability given the learning correct/incorrect log.

The first knowledge model learning unit 31 may also generate characteristics of the problem used for the learning (hereinafter referred to as the problem characteristic vector). The first knowledge model learning unit 31 may also generate, as similar to the generation of skill state sequences, the problem characteristic vectors using the method described in NPL 2.

The problem characteristic vector can be generated without relying on the learning results. For example, as described in NPL 1, a problem characteristic vector can be generated as a vector for problem i, with the i-th entry being 1 and the other entries being 0. This problem characteristic vector is a so-called one-hot vector ([0, . . . , 1, . . . , 0]) that identifies each problem. If the problem characteristic vector can be generated in this way, the first knowledge model learning unit 31 does not need to generate the problem characteristic vector.

The following is a specific description of the skill state sequence and the problem characteristic vector when using the method described in NPL 2.

The skill state sequence in this exemplary embodiment corresponds to the state transition probabilities in a generative model of uncompensated time-series IRT (item response theory) described in NPL 2 (and initial state probabilities). Therefore, the first knowledge model learning unit 31 may generate the skill state sequence by learning the model defined in equation 1 below. Equation 1 is a model that, given the state zⱼ^{(t)} of user j at time t, transitions to the next state zⱼ^{(t+1)} by linear transformation D. Note that zⱼ^{(t)} is a random variable.

$$[ Math . 1 ]$$

$$p ( {z}_{j}^{( t + 1 )} \vert {z}_{j}^{( t )} ) = ( {z}_{j}^{( t + 1 )} \vert {D}_{i ( j , t )} {z}_{j}^{( t )} + [ \begin{matrix}⋮ \\ {β}_{k}^{T} {x}_{j , k}^{( t + 1 )} \\ ⋮\end{matrix} ] , {Γ}_{i ( j , t + 1 )} ) \qquad ( Equation 1 )$$

$$p ( {z}_{j}^{( t )} ) = ( {z}_{j}^{( t )} \vert {μ}_{0} , {P}_{0} )$$

In equation 1, D_{i(j, t)} represents linear transformation that change states according to the problem i solved by user j at time t, and Γ_{i(j, t+1)} represents Gaussian noise. The second term on the right side is the bias term, which represents the feature of user j that can affect the state transition.

Specifically, x_{j, k}^{(t+1)} is a covariate of the state transition, and any characteristic about the learner is used as the user characteristic. The user characteristics include, for example, learner attributes (e.g., age, gender), motivation (interest in the subject), and the rate of forgetting 2\hat{ }(−Δ/h) assumed from the time elapsed since learner j last learned a problem involving skill k (where Δ is the elapsed time and h is a half-life), etc.

Other aggregate information on a result series may also be used as user characteristics. Aggregate information may include, for example, the number of responses to five consecutive correct answers for each skill, information indicating how quickly the user has mastered the skill, results of previous tests, etc.

In addition, βₖ^{T} is a coefficient that represents the characteristics of each skill; for example, a large negative value is set for the coefficient of a skill that is easily forgotten. In addition, μ₀ and P₀ represent the mean and variance of the Gaussian distribution of the learner's initial state, respectively.

The vector including aᵢ and bᵢ included in the output probabilities described in NPL 2 corresponds to the problem characteristic vector in this exemplary embodiment. Note that aᵢ is a vector representing the identification power (slope) of each skill in problem i, and bᵢ is difficulty of problem i. Therefore, the first knowledge model learning unit 31 may generate the problem characteristic vector by learning the model defined in equation 2 below. Q_{i(j, t), k} in equation 2 indicates the correspondence between problem i and skill k, and becomes 1 if skill k is needed to solve problem i and 0 if it is not needed.

[Math. 2]

p(yⱼ^{(t)}=1|zⱼ^{(t)})=Πₖσ(a_{i(j,t),k}(z_{j,k}^{(t)}−b_{i(j,t),k}))^{Q}^{_{i(j,t),k}} (Equation 2)

Specifically, the first knowledge model learning unit 31 may generate the problem characteristic vector as shown in equation 3 below. For example, if problem 1 requires skills 1 and 2, the first knowledge model learning unit 31 may generate the characteristic vector that sets entries except for a₁, a₂, b₁, and b₂ to 0 for the vector indicated the following equation 3.

$$[ Math . 3 ]$$

$${\underbrace{[ ⋯ , {a}_{k} , ⋯ ,}}_{{identification powe}_{( slope )} r} {\underbrace{⋯ , {b}_{k} , ⋯ ]}}_{difficulty} \qquad ( Equation 3 )$$

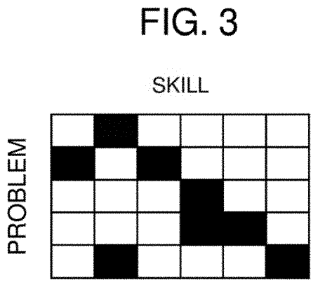

When generating the skill state sequences and the problem characteristic vectors using the method described in NPL 2, a table relating problems to required skills (problem skill correspondence table) should be prepared in advance during learning. FIG. 3 is an explanatory diagram showing an example of relating problems to the required skills. The example shown in FIG. 3 shows an example of relating problems to the skills required to solve them in a tabular format. As illustrated in FIG. 3, there may be one, two or more skills required for each problem. The relating problems to required skills is set in advance by the user or others.

Thus, the first knowledge model learning unit 31 may generate, as the problem characteristic vector, a vector including the identification power and difficulty of the problem ([ . . . , aₖ, . . . , . . . , bₖ, . . . ]).

Otherwise, the first knowledge model learning unit 31 may generate a skill state sequence using, for example, the method described in NPL 1. The skill state sequence in this exemplary embodiment corresponds to the vector yₜ of predicted probabilities of the time series described in NPL 1. The yₜ described in NPL 1 is a vector of length equal to the number of problems, where each entry represents the probability that the learner will answer the problem correctly. Thus, the first knowledge model learning unit 31 may generate the vector yₜ of predicted probabilities of the time series as the skill state sequence.

Also, as described above, the one-hot vector described in NPL 1 corresponds to the problem characteristic vector in this exemplary embodiment. Specifically, it can be generated as a vector for problem i, with the i-th entry being 1 and the other entries being 0. Thus, as the problem characteristic vector, a one-hot vector identifying each problem ([0, . . . , 1, . . . , 0]) may be generated in advance. In this case, the first knowledge model learning unit 31 does not need to generate the problem characteristic vector.

The methods for generating the skill state sequences and the problem characteristic vectors using the methods described in NPL 1 and NPL 2 were described above. However, methods for generating the skill state sequences and the problem characteristic vectors are not limited to the learning methods described in NPL 1 and NPL 2.

The second knowledge model learning unit 32 generates a model that predicts the future skill state of the learner by machine learning using the skill state sequence and the problem characteristic vector. Specifically, the second knowledge model learning unit 32 learns a model in which the problem characteristics, user characteristics, and time information are explanatory variables and the user skill state is an objective variable.

The skill states can be acquired from the skill state sequence generated by the first knowledge model learning unit 31. The problem characteristics may also be acquired from the problem characteristic vector generated by the first knowledge model learning unit 31, or from information (e.g., a one-hot vector) generated in any manner based on problems. The user characteristics are the same as those used by the first knowledge model learning unit 31 for learning. The time information is information that represents the time that the learner solved the problem. The form of the time information is arbitrary and can be, for example, time information expressed in the form of YYYYMMDDHHMM, or the elapsed time from a certain time t−1 to t, etc.

For example, using the method described in NPL 2, the first knowledge model learning unit 31 may generate a skill state sequence that maximizes the posterior probability as the skill state sequence. Specifically, with the obtained specific values of user j's results yⱼ⁽¹⁾, . . . , yⱼ^{(Tj)} indicated by the learning correct/incorrect log, the first knowledge model learning unit 31 should find the value of zⱼ^{(t)} (state variable) that maximizes the posterior probability up to t=1, . . . , T, as illustrated below.

[Math. 4]

P(zⱼ^{(t)}|yⱼ⁽¹⁾, . . . ,yⱼ^{(T}^{ⱼ}⁾)

The form of the model learned by the second knowledge model learning unit 32 is arbitrary, and the second knowledge model learning unit 32 may, for example, learn RNN, which is often used in the prediction of time-series data. For RNN, general RNN, LSTM (Long short-term memory), or GRU (Gated Recurrent Unit), etc. may also be used.

The learning of the model to perform knowledge tracing is generally performed using the learner's correct/incorrect data (the learning correct/incorrect log), as in the learning performed by the first knowledge model learning unit 31. On the other hand, the second knowledge model learning unit 32 in this exemplary embodiment learns models for knowledge tracing without directly using the learner's correct/incorrect data, and therefore, the model learned by the second knowledge model learning unit 32 can be referred to as a knowledge tracing model without correct/incorrect data.

By using the model learned in this way, a learner with the characteristics indicated by the user characteristics can predict changes in the state of a skill when selects (solves) a problem at a certain time. This makes it possible, for example, to predict the time-series changes in the state of skills for a future learning plan generated by the learner on his/her own initiative, if he/she executes the learning plan.

The output unit 40 outputs the model (knowledge tracing model without correct/incorrect data) generated by the second knowledge model learning unit 32. The output unit 40 may store the generated model in the storage unit 10 or may store the generated model in another storage medium (not shown) via a communication network.

The input unit 20, the learning unit 30 (more specifically, the first knowledge model learning unit 31 and the second knowledge model learning unit 32) and the output unit 40 are realized by a computer processor (e.g., CPU (Central Processing Unit), GPU (Graphics Processing Unit)) that operates according to a program (learning program).

For example, the program is stored in the storage unit 10, the processor reads the program, and may operate as the input unit 20, the learning unit 30 (more specifically, the first knowledge model learning unit 31 and the second knowledge model learning unit 32), and the output unit 40 according to the program. The functions of the input unit 20, the learning unit 30 (more specifically, the first knowledge model learning unit 31 and the second knowledge model learning unit 32), and the output unit 40 may be provided in a SaaS (Software as a Service) format.

The input unit 20, the learning unit 30 (more specifically, the first knowledge model learning unit 31 and the second knowledge model learning unit 32) and the output unit 40 may each be realized in dedicated hardware. In addition, some or all of each component of each device may be realized by general-purpose or dedicated circuits (circuitry), processors, etc. or a combination of these. They may be configured by a single chip or by multiple chips connected via a bus. Part or all of each component of each device may be realized by a combination of the above-mentioned circuits, etc. and a program.

In the case where some or all of each component of the input unit 20, the learning unit 30 (more specifically, the first knowledge model learning unit 31 and the second knowledge model learning unit 32) and the output unit 40 are realized by multiple information processing devices, circuits, etc., the multiple information processing devices, circuits, etc. may be arranged in a centralized or distributed arrangement. For example, the information processing devices and circuits, etc. may be realized as client-server systems, cloud computing systems, etc., each of which is connected via a communication network.

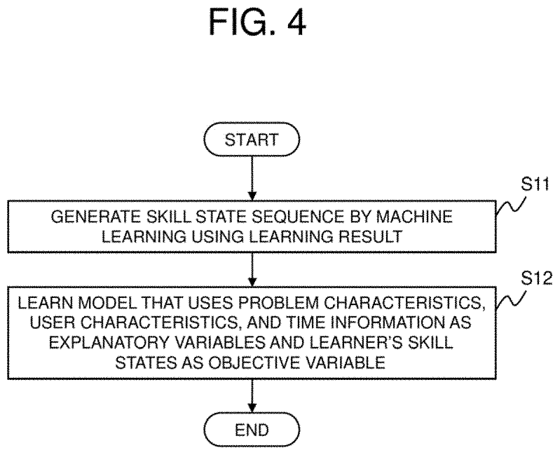

Next, the operation of the learning device 100 of this exemplary embodiment will be described. FIG. 4 is a flowchart showing an example of the operation by the learning device 100 of this exemplary embodiment. The learning unit 30 (more specifically, the first knowledge model learning unit 31) generates a skill state sequence by machine learning using the learning results (step S11). Then, the learning unit 30 (more specifically, the second knowledge model learning unit 32) learns a model that uses the problem characteristics, user characteristics, and time information as explanatory variables and the learner's skill states as objective variables (step S12).

As described above, in this exemplary embodiment, the first knowledge model learning unit 31 generates a skill state sequence by machine learning using the learning results, and the second knowledge model learning unit 32 learns a model in which the problem characteristics, user characteristics, and time information are explanatory variables and the learner's skill state is an objective variable. Thus, a model that predicts changes in the learner's long-term skills can be learned.

For example, the method described in NPL 2 learns a knowledge tracing model based on the learner's time-series learning correct/incorrect logs. In other words, the model described in NPL 2 is not suitable for long-term prediction because the correct/incorrect results of solving problems are required as learning data.

On the other hand, in this exemplary embodiment, the second knowledge model learning unit 32 learns a model in which the problem characteristics, user characteristics, and time information are explanatory variables and the learner's skill state is an objective variable. This makes it possible to make long-term predictions about the learner.

### Exemplary Embodiment 2

Next, a second exemplary embodiment of this invention will be described. The second exemplary embodiment describes a method for visualizing changes in the state of a learner's skills based on a learning plan. The learning plan in this exemplary embodiment is information that represents which problems the learner plans to solve, when and in what order, and is information that lists the problems the learner plans to solve in time series. This exemplary embodiment describes a method for visualizing how the state of one's skills will change once which problems are solved and when.

In the following description, the method of estimating changes in the state of skills using the model learned in the first exemplary embodiment and visualizing the results of the estimation will be described as appropriate. However, the method of estimating changes in the state of skills is not limited to the method using the model learned in the first exemplary embodiment.

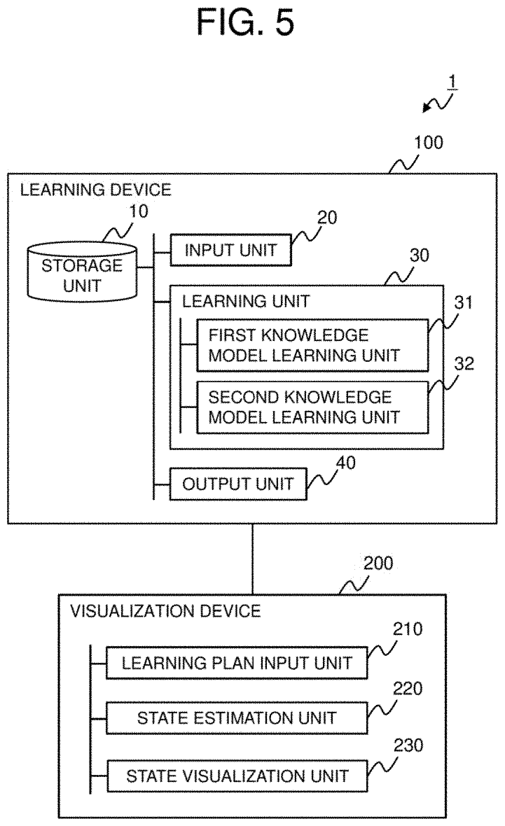

FIG. 5 is a block diagram showing an example of the configuration of a visualization system of an exemplary embodiment according to the present invention. The visualization system 1 of this exemplary embodiment includes a learning device 100 and a visualization device 200. Since the contents of the learning device 100 of this exemplary embodiment are the same as those of the learning device 100 of the first exemplary embodiment, a detailed description is omitted. It should be noted that the storage unit 10 included in the learning device 100 of the first exemplary embodiment may be provided in a different device from the learning device 100.

The visualization device 200 acquires the model learned by the learning device 100 (i.e., the knowledge tracing model without correct/incorrect data). If the information used by the visualization device 200 for processing (e.g., the above knowledge tracing model without correct/incorrect data, etc.) is stored in a storage device (e.g., the storage unit 10) provided in a device other than the learning device 100, the visualization device 200 may not be connected to the learning device 100.

The visualization device 200 includes a learning plan input unit 210, a state estimation unit 220, and a state visualization unit 230.

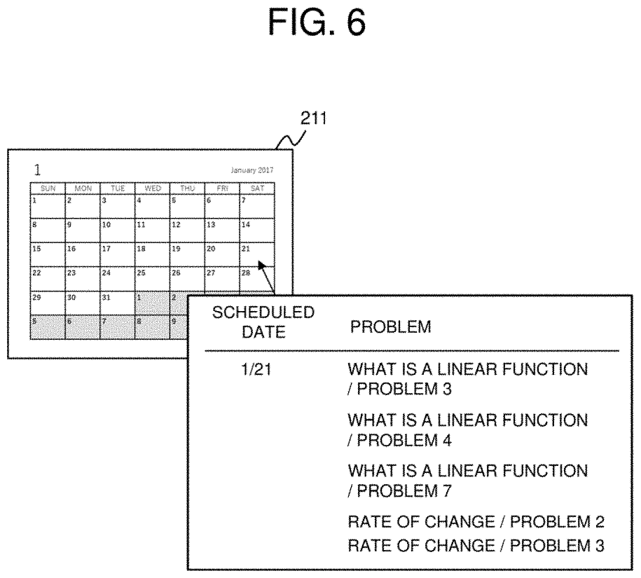

The learning plan input unit 210 accepts input of learning plans. The learning plan input unit 210 may, for example, display an input screen for the learning plans on a display device (not shown) and accept input of the learning plans interactively from the learner. FIG. 6 is an explanatory diagram showing an example of a screen for entering a learning plan. The learning plan input unit 210 may display an input screen 211 in calendar format, as illustrated in FIG. 6, and accept learning plans input by the learner via an appropriate input interface (e.g., touch panel, pointing device, keyboard, etc.).

The display device may be provided in the visualization device 200, and may be realized in a device different from the visualization device 200 connected via a communication line. In addition, the learning plan input unit 210 may also accept input of a learning plan recorded in a file or the like.

The state estimation unit 220 estimates the changes in the state of skills based on the learning plan. Specifically, the state estimation unit 220 estimates the changes in the state of the learner's skills when each problem scheduled in the learning plan is solved in time series.

Various methods can be used to estimate the changes in the state of skills. For example, the proficiency level of each skill that is estimated to improve when a problem is solved is predetermined, and the state estimation unit 220 may add (e.g., add, multiply, etc.) the proficiency level corresponding to the solved problem according to the learning plan to estimate the changes in the state of skills. Furthermore, the state estimation unit 220 may decrease the proficiency level of the skills according to a certain function (forgetting curve) as time passes.

In order to estimate the changes in the state of skills with greater precision, the state estimation unit 220 may use the model learned in the first exemplary embodiment (knowledge tracing model without correct/incorrect data) to estimate the changes in the state of skills. In other words, the state estimation unit 220 may estimate the changes in the state of skills using a prediction model in which the problem characteristics that represent the characteristics of the problems used by the learner for learning, the user characteristics that represent the characteristics of the learner, and the time information that represents the time the learner solved the problem are explanatory variables, and the learner's skill state is an objective variable.

As shown in the first exemplary embodiment, the above prediction model is a model learned using data including a skill state sequence representing time-series changes in the learner's skill state generated by machine learning using the learner's learning results, and the feature based on a problem characteristic vector representing the characteristics of the problems used by the learner for learning.

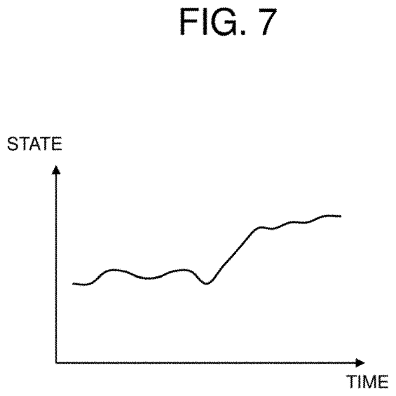

The state visualization unit 230 visualizes the estimated learner's skill state. FIG. 7 is an explanatory diagram showing an example of visualizing skill states. As illustrated in FIG. 7, the learner's skill state at each point in time may be visualized in time series, in a line graph with time set on the horizontal axis and skill state (proficiency level) set on the vertical axis.

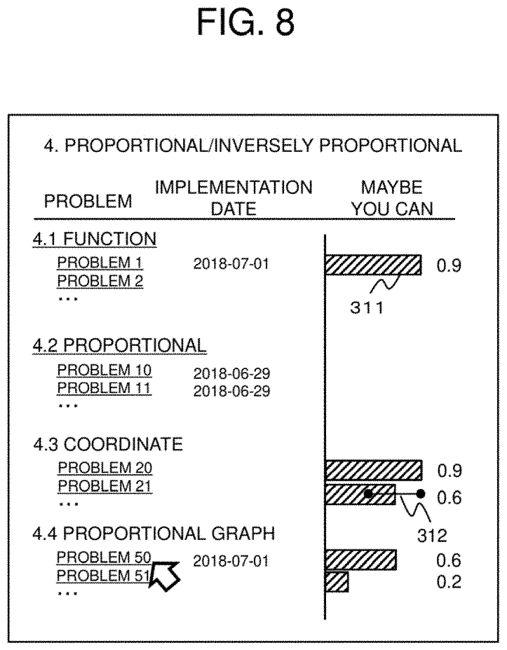

The state visualization unit 230 may also visualize the learner's probability of correct answers at a specified point in time for each problem. FIG. 8 is an explanatory diagram showing an example of visualizing the probability of solving a problem. The example shown in FIG. 8 shows an example of visualizing the probability of correct answers as a bar chart 311 for each problem grouped by unit.

The state visualization unit 230 may, for example, estimate the learner's skill state at a certain point in time using a knowledge tracing model without correct/incorrect data, and compute the probability of correct answers based on the estimated skill. For example, when using the method described in NPL 2, the state visualization unit 230 may compute the probability of correct answers for each problem using equation 2 shown above and visualize the computed results. Specifically, the state visualization unit 230 may visualize the mean in the distribution of the probability of correct answers computed using equation 2 as the probability of correct answers in a bar graph 311, and represent the variance as the degree of uncertainty in a line 312.

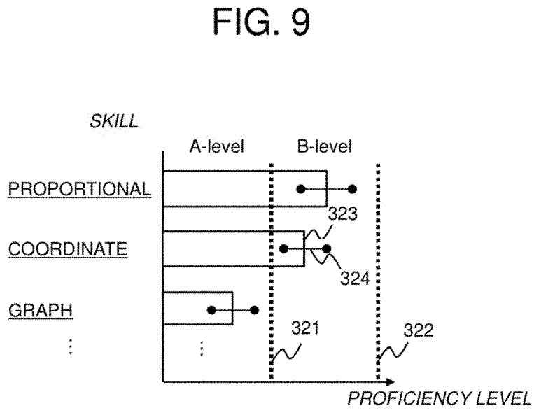

The state visualization unit 230 may also visualize the learner's each skill state at a given point in time in more detail. For example, the state visualization unit 230 may visualize the learner's skills assumed at a specified point in time for each skill required to solve the target problem. FIG. 9 is an explanatory diagram showing an example of outputting the state of each skill by a graph. The graph illustrated in FIG. 9 is a graph visualizing the learner's skill state for each skill required to solve a certain problem. In the example shown in FIG. 9, for example, the status that a problem provider labels two types (A-level, B-level) according to the level of the problem is assumed. As a specific example of the labeling, a problem with the label “A-level” (hereafter referred to as A problem) is a standard problem, and a problem with the label “B-level” (hereafter referred to as B problem) is a developmental problem, etc.

In the example shown in FIG. 9, the thresholds for each level of skill are indicated by boundaries, where a boundary 321 is the threshold for the skill state at which all A problems are assumed to be solved, a boundary 322 is the threshold for the skill state at which all B problems are assumed to be solved. In the example shown in FIG. 9, each skill state at a given point in time is represented by a bar chart 323, and the degree of uncertainty of that skill state is represented by a circled line 324.

Hereinafter, it is explained how to visualize the skill state illustrated in FIG. 9, using the non-compensating item response model described in the above NPL 2 as an example. First, it is explained how to identify the boundary (i.e., threshold) illustrated in FIG. 9.

When skills are associated with a certain problem, it is common to assume that the problem can be solved by satisfying all of those skills. Such a model, described in NPL 2, is called a non-compensating type model in multidimensional item response theory. The explanation of the reason for the prediction using this non-compensating type model is natural.

In a non-compensating type model, the model predicting the probability of correct answers is represented by the product of each skill. For example, if the coefficients of each skill s₁, s₂ are t₁, t₂ respectively, the prediction model can be expressed using the sigmoid function σ as follows. Such a non-compensating type model is highly explanatory because it is interpreted as “the above problem cannot be solved without knowledge of fractions and equations”.

Probability of correct answer=σ(t₁s₁)σ(t₂s₂)

When the learner's state z and problem i are given, the model representing the probability that a learner can solve that problem i, can be defined, for example, by the following illustrated equation 4, which is a simplified version of above equation 2. That is, the model illustrated in equation 4 is a model that is represented by a combination of the skills k that the learner needs to solve problem i, and the probability of solving the problem by the product of each skill is computed. The learner's state z represents the proficiency level of each skill k possessed by the learner at a given point in time.

$$[ Math . 5 ]$$

$$p ( {a}_{i} , {b}_{i} , z ) = {\prod }_{k} σ ( {a}_{i , k} ( {z}_{k} - {b}_{i , k} ) ) \qquad ( Equation 4 )$$

In equation 4, as in equation 2 above, b_{i, k} represents the difficulty of skill k used in problem i, and a_{i, k} is a parameter that represents the degree of rise (slope) of skill k with respect to problem i. In other words, equation 4 represents that if the proficiency level of the skills zₖ is higher than the difficulty indicated by b_{i, k}, the problem will be solved with a higher probability.

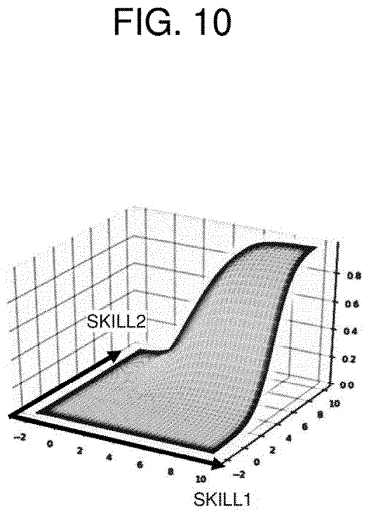

FIG. 10 is an explanatory diagram showing an example of a likelihood function for the probability of correct answers. In the graph illustrated in FIG. 10, the vertical axis (z-axis) represents the probability of correct answers, and the other axes (x-axis and y-axis) represent the proficiency level of the skills required to solve that problem. Specifically, the likelihood function illustrated in FIG. 10 is represented by equation 4 illustrated above. For example, it is supposed that two skills are required to solve a certain problem, as illustrated in FIG. 10. In this case, the probability of correct answers does not increase if only one skill is high, but the probability of correct answers increases when both skills are high.

For example, in the example shown in FIG. 10, it is supposed that the administrator assumes to need a proficiency level of the skills in which the probability of correct answers=80% in order to solve all the problems of a certain level (e.g., A-level). In this case, the cross-section when cut perpendicular to the axis of the probability of correct answers, which is the value of the likelihood function, at the position of the probability of correct answers=0.8, represents the range of the proficiency level of the skills.

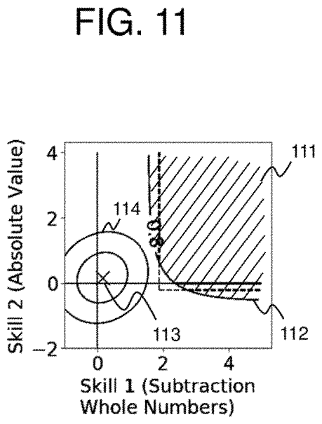

FIG. 11 is an explanatory diagram representing the information of the uncompensated model schematically. The information illustrated in FIG. 11, for example, is information for handling the non-compensating type model inside the analysis engine, and indicates that two skills (“integer subtraction” and “absolute value”) are required for the target problem. In this case, it is also assumed that the proficiency level of the skills is specified as being necessary to solve problem A, such that the probability of correct answers=80%.

The shaded area 111 in the upper right corner of the graph shows the range of the proficiency level of the skills in the likelihood function illustrated in FIG. 10, where the probability of correct answers=80%. The curve 112 marked “0.8” indicates the boundary of the proficiency level of the skills required to satisfy the probability of correct answers=80%. The X mark 113 shown in the lower left corner of the graph indicates the learner's skill state at this point in time. The ellipse 114 surrounding the X mark 113 indicates the contour line of the probability in the case that the distribution of the learner's skill state follows the Gaussian distribution. In this case, the position of the learner's skill state corresponds to the mean in the Gaussian distribution.

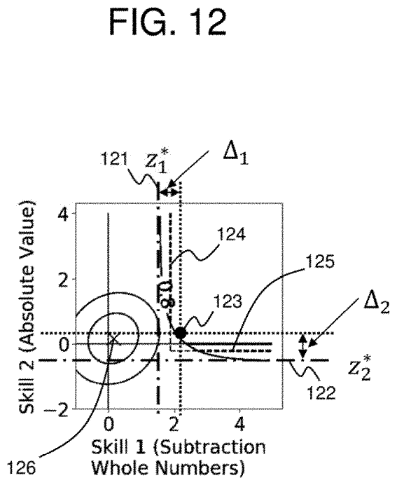

Based on this assumption, the state visualization unit 230 computes a threshold value. The threshold value computed here corresponds to the threshold value indicated by the boundary 321 illustrated in FIG. 9. FIG. 12 is an explanatory diagram showing an example of the process of computing a threshold value. First, the state visualization unit 230 computes the coordinates zₖ* for each dimension. For example, the state visualization unit 230 computes zₖ* based on equation 4 above and using equation 5 illustrated below.

$$[ Math . 6 ]$$

$${z}_{k}^{+} = \frac{{σ}^{- 1} ( p )}{{a}_{i}} + {b}_{i} \qquad ( Equation 5 )$$

Note that p in equation 5 indicates the probability of correct answers, and aᵢ and bᵢ indicate slope and difficulty, respectively, as in equation 4. Since it is assumed a proficiency level of the skills at which all problems A can be solved, the most difficult problem i of the problems A should be selected as the problem. The zₖ* computed here corresponds to the coordinates of the surface tangent to the likelihood function illustrated in FIG. 10 from the outside, and corresponds to the long chain lines 121 and 122 in FIG. 12.

Next, the state visualization unit 230 searches coordinates z\hat{ } (superscript hat of z) that come closest to Δ₁=Δ₂= . . . =Δ_{K} (where K is the number of skills required) while changing the coordinates on the boundary. Note that Δ is the difference between zₖ* and z\hat{ } computed for each dimension. The z\hat{ } computed here corresponds to the coordinates of the surface tangent to the likelihood function illustrated in FIG. 10 from the inside, and corresponds to the coordinates of point 123 in FIG. 12.

Specifically, the state visualization unit 230 repeats the following two processes in computing the coordinates z\hat{ }. First, as the first process, the state visualization unit 230 computes zₖ={σ⁻¹(p^{-k})/aᵢ}+bᵢ as the initial point. Then, the state visualization unit 230 computes the value of each Δₖ based on this zₖ. Next, as a second process, the state visualization unit 230 performs the update shown in equation 6 below for dimension k for the largest Δₖ. Note that δ is a parameter and is predetermined.

zₖₘₐₓ←zₖₘₐₓ−δ (Equation 6)

Then, the state visualization unit 230 makes the updated zₖₘₐₓ as z′, and performs the update shown the following equation 7 for the dimension k about the smallest Δₖ. The state visualization unit 230 repeats these two processes until predetermined conditions (e.g., the amount of change is less than a threshold value, predetermined number of times, etc.) are satisfied.

$$[ Math . 7 ]$$

$$\begin{matrix}scale = p ( {a}_{i} , {b}_{i} , {z}^{′} ) / p ( {a}_{i} , {b}_{i} , z ) & ( Equation 7 )\end{matrix}$$

$${p}_{kmin} = \frac{σ ( {a}_{i} ( {z}_{kmin} - {b}_{kmin} ) )}{scale}$$

$${z}_{kmin} ← \frac{{σ}^{- 1} ( {p}_{kmin} )}{{a}_{i}} + {b}_{i}$$

Next, the state visualization unit 230 computes (z\hat{ }ₖ−zₖ*)/2 for each k to rectangular-approximate the region. The values computed here correspond to the coordinates of the dashed lines 124 and 125 in FIG. 12.

The state visualization unit 230 then outputs a bar graph based on the ratio between the proficiency level of the learner's skills and the value indicated by the rectangular-approximated coordinates. Specifically, the state visualization unit 230 may output a bar graph based on the ratio of the coordinates 126 indicating the learner's skill state and the coordinates indicated by the dashed lines 124 and 125. In this way, the state visualization unit 230 outputs the proficiency level of the skills required to solve the target problem (i.e., the threshold value) relating to the proficiency level of the skills that the learner is assumed to have. The same is true for the threshold value for problem B.

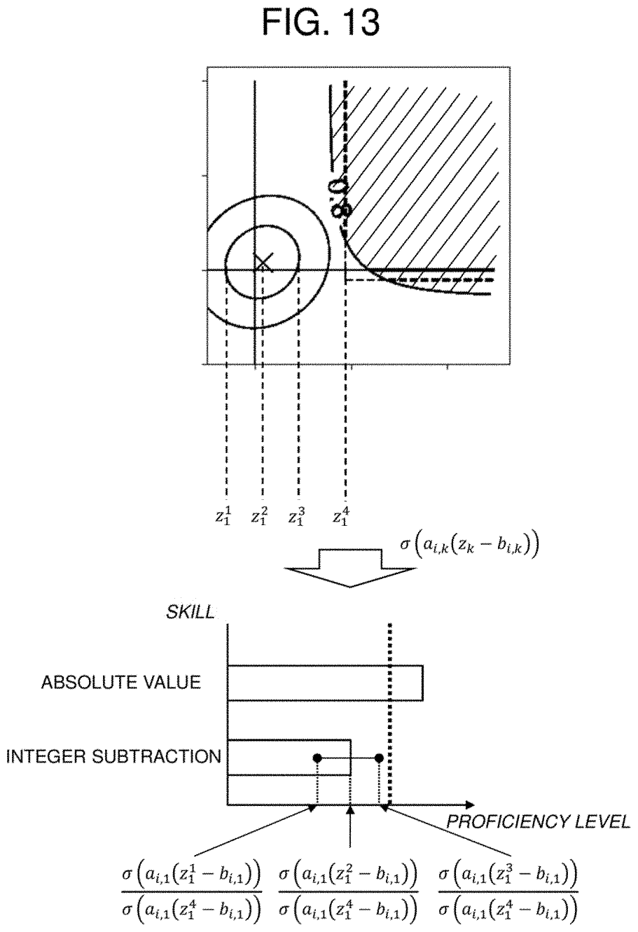

In addition, the state visualization unit 230 outputs the uncertainty of the learner's skill state together. FIG. 13 is an explanatory diagram showing an example of the process of visualizing the results. For example, it is supposed that the learner's skill state for skill 1 (integer subtraction) is estimated to be z₁² and the variance ±σ of the skill state in the Gaussian distribution is z₁¹ and z₁³, respectively. Then, it is supposed that the coordinates of the dashed line 124 in FIG. 12 are computed to be z₁⁴. At this time, the state visualization unit 230 computes the proficiency level of the learner's skill 1 as σ (a_{i, 1}(z₁²−b_{i, 1}))/σ(a_{i, 1}(z₁⁴−b_{i, 1})).

The state visualization unit 230 may also output the variance of the Gaussian distribution as the uncertainty of the proficiency level, using the distribution indicating the learner's skill state estimated by the Gaussian distribution. Specifically, the state visualization unit 230 computes the range of uncertainty as σ(a_{i, 1}(z₁¹−b_{i, 1}))/σ(a_{i, 1}(z₁⁴−b_{i, 1})) and σ(a_{i, 1}(z₁³−b_{i, 1}))/σ(a_{i, 1}(z₁⁴−b_{i, 1})). The same is true for skill 2 (absolute value).

Thus, the state visualization unit 230 computes the relative proficiency level of the skills and uncertainty when the threshold value is set to 1. In other words, the state visualization unit 230 expresses the current proficiency level and uncertainty of the learner's skill relative to the threshold value as relative values, associating with the skill name. Thus, the learner's skill over/under can be presented based on skill names that are understandable to the learner. Furthermore, the state visualization unit 230 can also improve the learner's sense of conviction by expressing the uncertainty of each skill together.

In addition, since the difficulty of the problems output by the analysis algorithm generally has no units, it may be difficult to grasp the degree of the skill state just by looking at the value indicating the difficulty. In this exemplary embodiment, the state visualization unit 230 relates the proficiency level of the learner's skills assumed at a specified point in time to the threshold value indicating the proficiency level of the skills required to solve the problem (e.g., the problem A, problem B) included in the target group (e.g., the labeled group) to visualize. Thus, since the groups specified by the problem provider are related to the estimated difficulty, it is easier to grasp the learner's skill state. The number of problems in a group may be one or more.

Furthermore, the state visualization unit 230 may output the candidate problems requiring the specified skills as “recommended problems”. Specifically, the state visualization unit 230 may identify candidate problems that require the specified skills from a table that relates problems to the skills required to solve them, as illustrated in FIG. 3.

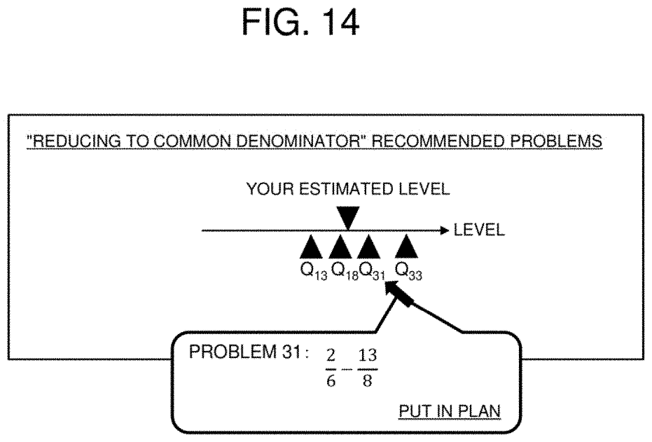

FIG. 14 is an explanatory diagram showing an example of the output of recommended problems. The example shown in FIG. 14 shows that the state visualization unit 230 outputs, for the “reducing to a common denominator” skill, candidate problems that require the skill (recommended problems: Q₁₃, Q₁₈, Q₃₁, Q₃₃), ordered according to the degree to which the skill is required (i.e., proficiency level, difficulty), and related with the assumed learner's skill.

As illustrated in FIG. 14, when a learner mouses over a recommended problem number with a pointing device such as a mouse, the state visualization unit 230 may output the problem corresponding to the number.

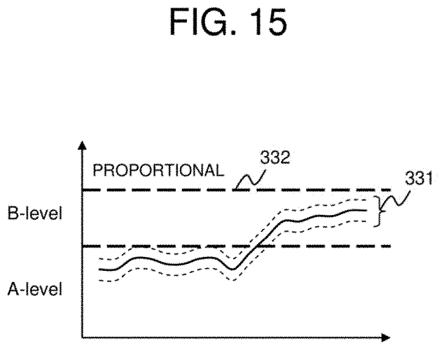

The state visualization unit 230 may also visualize other changes including the uncertainty in the skill state. FIG. 15 is an explanatory diagram showing another example of visualizing changes in skill state. As illustrated in FIG. 15, the state visualization unit 230 may use a line graph with time set on the horizontal axis and proficiency level of the skills set on the vertical axis to visualize time-series changes in the skill state with range of uncertainty 331. In doing so, the state visualization unit 230 may also visualize the boundaries 332 of the labeled problems as shown above together.

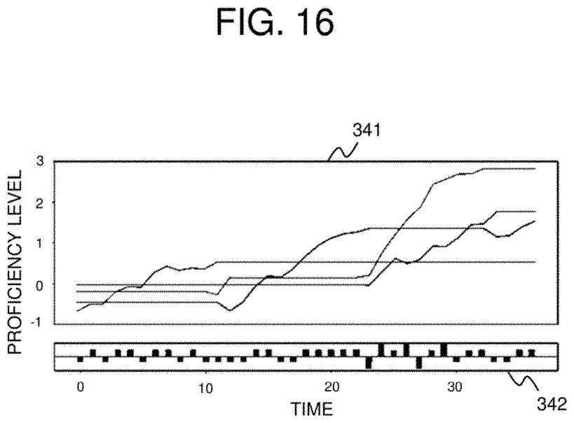

The state visualization unit 230 may also visualize changes in the state of multiple skills. FIG. 16 is an explanatory diagram showing yet another example of visualizing changes in skill state. In the example shown in FIG. 16, a line graph 341 represents the transition of the state of the multiple skills, respectively. In order to be able to grasp the transition of skills in relation to learning results, the state visualization unit 230 may also visualize the correct/incorrect of problems solved at each point in time in a bar graph 342 (e.g., upward for correct answers and downward for incorrect answers) as illustrated in FIG. 16.

The learning plan input unit 210, the state estimation unit 220, and the state visualization unit 230 are realized by a computer processor that operates according to a program (visualization program). For example, the program is stored in a storage unit (not shown) included in the visualization device 200, and the processor reads the program and may operate as the learning plan input unit 210, the state estimation unit 220, and the state visualization unit 230 according to the program. The functions of the learning plan input unit 210, the state estimation unit 220, and the state visualization unit 230 may be provided in a SaaS format.

The learning plan input unit 210, the state estimation unit 220, and the state visualization unit 230 may each be realized in dedicated hardware. In addition, some or all of each component of each device may be realized by general-purpose or dedicated circuits (circuitry), processors, etc. or a combination of these. They may be configured by a single chip or by multiple chips connected via a bus. Part or all of each component of each device may be realized by a combination of the above-mentioned circuits, etc. and a program.

In the case where some or all of each component of the learning plan input unit 210, the state estimation unit 220, and the state visualization unit 230 are realized by multiple information processing devices, circuits, etc., the multiple information processing devices, circuits, etc. may be arranged in a centralized or distributed arrangement. For example, the information processing devices and circuits, etc. may be realized as client-server systems, cloud computing systems, etc., each of which is connected via a communication network.

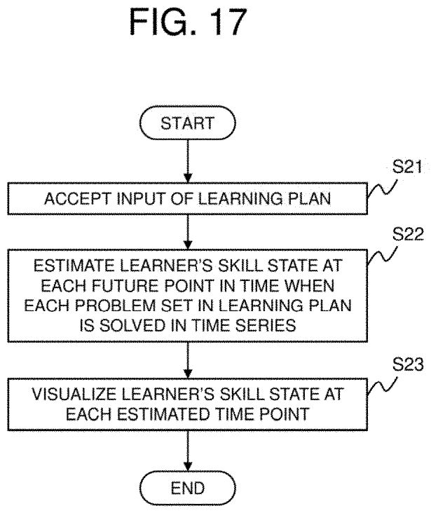

Next, the operation of the visualization device 200 of this exemplary embodiment will be described. FIG. 17 is a flowchart showing an example of the operation by the visualization device 200 of this exemplary embodiment. The learning plan input unit 210 accepts input of a learning plan (step S21). The state estimation unit 220 estimates the learner's skill state at each future point in time when each problem set in the learning plan is solved in time series (step S22). Then, the state visualization unit 230 visualizes the learner's skill state at each estimated time point (step S23). The form of visualization is, for example, the contents shown in FIGS. 7 to 9 and FIGS. 13 to 16, etc.

As described above, in this exemplary embodiment, the learning plan input unit 210 accepts input of a learning plan, and the state estimation unit 220 estimates the learner's skill state at each future point in time when the learner solves each problem set in the learning plan in time series. Then, the state visualization unit 230 visualizes the learner's skill state at each estimated time point. Thus, changes in the learner's skills over time can be visualized.

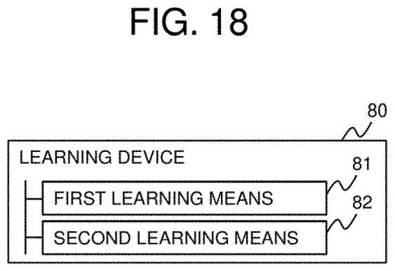

Next, an overview of the present invention will be described. FIG. 18 is a block diagram showing an overview of the learning device according to the present invention. The learning device 80 (e.g., the learning device 100) according to the present invention includes a first learning means 81 (e.g., the first knowledge model learning unit 31) which generates a skill state sequence representing time-series changes in a learner's skill state by machine learning using learner's learning results (learning results), and a second learning means 82 (e.g., the second knowledge model learning unit 32) which learns a model in which problem characteristics that represent characteristics of problems used by a learner for learning, user characteristics that represent characteristics of the learner, and time information that represents time the learner solved the problem are explanatory variables, and the learner's skill state represented by the skill state sequence is an objective variable.

With such a configuration, it is possible to learn a model for predicting changes in long-term skills.

The first learning means 81 may generate states that maximize a posterior probability under given learning results as the skill state sequence.

Otherwise, the first learning means 81 may generate a vector of time-series prediction probabilities as the skill state sequence.

The first learning means 81 may perform machine learning using learning results that relates problems and correctness or incorrectness of those problems to the user characteristics that represent the characteristics of the learner as the learning results. Such learning can predict changes in the user skills with similar user characteristics in the same way.

The second learning means 82 may learn a recurrent neural network as the model (also the LSTM, the GRU, etc.).

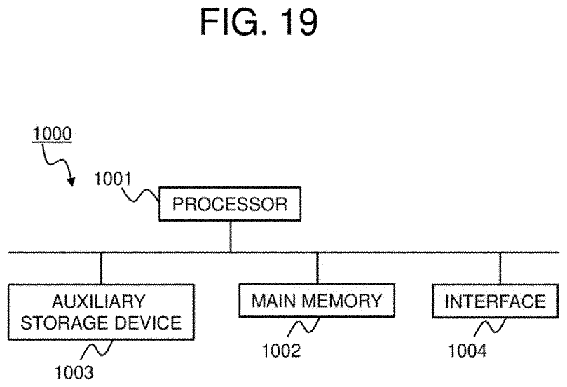

FIG. 19 is a schematic block diagram showing the configuration of a computer for at least one exemplary embodiment. The computer 1000 has a processor 1001, a main storage device 1002, an auxiliary storage device 1003, and an interface 1004.

The above-mentioned learning device 80 is implemented in a computer 1000. The operations of each of the above-mentioned processing units are stored in the auxiliary storage device 1003 in the form of a program (learning program). The processor 1001 reads the program from the auxiliary storage device 1003, expands the read program into the main storage device 1002 and executes the above processing according to said program.

In at least one exemplary embodiment, the auxiliary storage device 1003 is an example of a non-temporary tangible medium. Other examples of non-temporary tangible medium include magnetic disks connected via the interface 1004, magneto-optical disks, CD-ROM (Compact Disc Read-only memory), DVD-ROM (Read-only memory), semiconductor memory, etc. When the program is delivered to a computer 1000 through a communication line, the computer 1000 which is received delivery, may expand the program into the main storage device 1002 and execute the above process.

The said program may also be used to realize some of the aforementioned functions. Furthermore, said program may be a so-called difference file (difference program), which realizes the aforementioned functions in combination with other programs already stored in the auxiliary storage device 1003.

Some or all of the aforementioned exemplary embodiment can be described as supplementary notes mentioned below, but are not limited to the following supplementary notes.

(Supplementary note 1) A learning device comprising: a first learning means which generates a skill state sequence representing time-series changes in a learner's skill state by machine learning using learner's learning results; and a second learning means which learns a model in which problem characteristics that represent characteristics of problems used by a learner for learning, user characteristics that represent characteristics of the learner, and time information that represents time the learner solved the problem are explanatory variables, and the learner's skill state represented by the skill state sequence is an objective variable.

(Supplementary note 2) The learning device according to Supplementary note 1, wherein the first learning means generates states that maximize a posterior probability under given learning results as the skill state sequence.

(Supplementary note 3) The learning device according to Supplementary note 1, wherein the first learning means generates a vector of time-series prediction probabilities as the skill state sequence.

(Supplementary note 4) The learning device according to any one of Supplementary notes 1 to 3, wherein the first learning means performs machine learning using learning results that relates problems and correctness or incorrectness of those problems to the user characteristics that represent the characteristics of the learner as the learning results.

(Supplementary note 5) The learning device according to any one of Supplementary notes 1 to 4, wherein the second learning means learns a recurrent neural network as the model.

(Supplementary note 6) A learning method implemented by a computer, comprising: generating a skill state sequence representing time-series changes in a learner's skill state by machine learning using learner's learning results; and learning a model in which problem characteristics that represent characteristics of problems used by a learner for learning, user characteristics that represent characteristics of the learner, and time information that represents time the learner solved the problem are explanatory variables, and the learner's skill state represented by the skill state sequence is an objective variable.

(Supplementary note 7) The learning method implemented by the computer according to Supplementary note 6, further comprising: generating states that maximize a posterior probability under given learning results as the skill state sequence.

(Supplementary note 8) The learning method implemented by the computer according to Supplementary note 6, further comprising: generating a vector of time-series prediction probabilities as the skill state sequence.

(Supplementary note 9) A program storage medium that stores a learning program causing a computer to execute: a first learning process of generating a skill state sequence representing time-series changes in a learner's skill state by machine learning using learner's learning results; and a second learning process of learning a model in which problem characteristics that represent characteristics of problems used by a learner for learning, user characteristics that represent characteristics of the learner, and time information that represents time the learner solved the problem are explanatory variables, and the learner's skill state represented by the skill state sequence is an objective variable.

(Supplementary note 10) The program storage medium according to Supplementary note 9, wherein the learning program causes the computer to store a learning program for generating states that maximize a posterior probability under given learning results as the skill state sequence, in the first learning process.

(Supplementary note 11) The program storage medium according to Supplementary note 9, wherein the learning program causes the computer to store a learning program for generating a vector of time-series prediction probabilities as the skill state sequence, in the first learning process.

(Supplementary note 12) A learning program causing a computer to execute: a first learning process of generating a skill state sequence representing time-series changes in a learner's skill state by machine learning using learner's learning results; and a second learning process of learning a model in which problem characteristics that represent characteristics of problems used by a learner for learning, user characteristics that represent characteristics of the learner, and time information that represents time the learner solved the problem are explanatory variables, and the learner's skill state represented by the skill state sequence is an objective variable.

(Supplementary note 13) The learning program according to Supplementary note 12, causing the computer to execute: wherein the learning program causes the computer to generate states that maximize a posterior probability under given learning results as the skill state sequence, in the first learning process.

(Supplementary note 14) The learning program according to Supplementary note 12, causing the computer to execute: wherein the learning program causes the computer to store a learning program for generating a vector of time-series prediction probabilities as the skill state sequence, in the first learning process.

While the present invention has been explained with reference to the exemplary embodiments, the present invention is not limited to the aforementioned exemplary embodiments. Various changes understandable to those skilled in the art within the scope of the present invention can be made to the structures and details of the present invention.

### REFERENCE SIGNS LIST

1 Visualization system
10 Storage unit
20 Input unit
30 Learning unit
31 First knowledge model learning unit
32 Second knowledge model learning unit
40 Output unit
100 Learning device
200 Visualization device
210 Learning plan input unit
220 State estimation unit
230 State visualization unit

What is claimed is:

1. A learning device comprising:
a memory storing instructions; and
one or more processors configured to execute the instructions to:
generate a skill state sequence representing time-series changes in a learner's skill state by machine learning using learner's learning results; and
learn a model in which problem characteristics that represent characteristics of problems used by a learner for learning, user characteristics that represent characteristics of the learner, and time information that represents time the learner solved the problem are explanatory variables, and the learner's skill state represented by the skill state sequence is an objective variable.

2. The learning device according to claim 1,
wherein the processor is configured to execute the instructions to generate states that maximize a posterior probability under given learning results as the skill state sequence.

3. The learning device according to claim 1,
wherein the processor is configured to execute the instructions to generate a vector of time-series prediction probabilities as the skill state sequence.

4. The learning device according to claim 1,
wherein the processor is configured to execute the instructions to perform machine learning using learning results that relates problems and correctness or incorrectness of those problems to the user characteristics that represent the characteristics of the learner as the learning results.

5. The learning device according to claim 1,
wherein the processor is configured to execute the instructions to learn a recurrent neural network as the model.

6. A learning method implemented by a computer, comprising:
generating a skill state sequence representing time-series changes in a learner's skill state by machine learning using learner's learning results; and
learning a model in which problem characteristics that represent characteristics of problems used by a learner for learning, user characteristics that represent characteristics of the learner, and time information that represents time the learner solved the problem are explanatory variables, and the learner's skill state represented by the skill state sequence is an objective variable.

7. The learning method implemented by the computer according to claim 6, further comprising:
generating states that maximize a posterior probability under given learning results as the skill state sequence.

8. The learning method implemented by the computer according to claim 6, further comprising:
generating a vector of time-series prediction probabilities as the skill state sequence.

9. A non-transitory computer readable information recording medium storing a learning program, when executed by a processor, that performs a method for:
generating a skill state sequence representing time-series changes in a learner's skill state by machine learning using learner's learning results; and
learning a model in which problem characteristics that represent characteristics of problems used by a learner for learning, user characteristics that represent characteristics of the learner, and time information that represents time the learner solved the problem are explanatory variables, and the learner's skill state represented by the skill state sequence is an objective variable.

10. The non-transitory computer readable information recording medium according to claim 9,
wherein states that maximize a posterior probability under given learning results is generated as the skill state sequence.

11. The non-transitory computer readable information recording medium according to claim 9,
wherein a learning program for generating a vector of time-series prediction probabilities as the skill state sequence is stored
